(19) United States
(12) Patent Application Publication
(10) Pub. No.: US 2025/0173916 A1
(43) Pub. Date: May 29, 2025

(54) SYSTEM AND METHODS FOR QUANTIFYING AND CALCULATING WINDOW VIEW OPENNESS INDEXES

(71) Applicant: The University of Hong Kong, Hong Kong (CN)

(72) Inventors: Anthony Gar On YEH, Hong Kong (CN); Maosu LI, Hong Kong (CN); Fan XUE, Hong Kong (CN)

(21) Appl. No.: 18/841,600

(22) PCT Filed: Feb. 23, 2023
(86) PCT No.: PCT/CN2023/077947

§ 371 Date: Aug. 26, 2024

Related U.S. Application Data
(60) Provisional application No. 63/269,891, filed on Mar. 24, 2022.

(51) Int. Cl. G06T 11/00; G06T 7/50

(52) U.S. Cl. CPC G06T 11/00; G06T 7/50; G06T 2207/30181

(57) ABSTRACT

A method and systems for quantifying and calculating window view openness indexes based on window view photos and view distances are provided. The method includes generating a window view image by an image capturing device; computing a distant view layer proportion; measuring and computing a close-range view layer distance; computing a view distance-based openness adjustment factor (OAF); and computing a window view openness index (WVOI). The computing of a distant view layer proportion may include extracting a proportion of a distant layer of the window view image as a basic factor to measure view openness. The OAF is summarized from view distances computed in the step of measuring and computing a close-range view layer distance. The WVOI is calculated based on the proportion of distant view layer and the OAF from the close-range view layer distance.

### BACKGROUND OF THE INVENTION

### Importance and Application of Window View Openness

Window view openness is a key attribute of living and working space such as residence and office, which significantly influences the human life quality in terms of mental and physical wellbeing and satisfaction. In general, windows with more distant view elements (for example, building, greenery, waterbody, and sky) have more openness than those with close-range scenes. It has been found that a human brain has specific regions to recognize and detect environmental openness that often results in feelings of relaxation and comfort. Compared to the close-range window views, urban dwellers are willing to pay a premium for distant views with great openness. Urban dwelling with less window view openness can lead to urban pathologies, such as depression and mood disorder. Thus, the quantification of window view openness is important in real estate valuation and in the planning and designing of pleasing, healthy, and sustainable urban environments.

### Window View Openness and Openness Index

Window view openness is determined by distances from a window to visible elements, such as sky, buildings, greenery, and waterbody. Window views with more proportions of the sky and distant landscape layers tend to provide greater openness. Compared to other view openness, such as street view openness, the quantification of window view openness received insufficient attention due to previous difficulty in data acquisition of window views in a large scale. Generally, the window view openness index (WVOI) can be computed as percentages of sky view or volumes of visible space. More visible sky elements and larger visible space indicate greater openness of the window view.

### Previous Investigations and Their Limitations

Visibility analysis and view photography are two ways for quantifying and computing window view openness.

Visibility analysis for window view openness aims to measure the visibility of predefined landscape objects. For example, Fisher-Gewirtzman (2018) measured a human-perceived window view openness on manual 3D models for urban planning and design. However, the calculation results are inaccurate due to the simplified simulation of the outside world. To realize a highly fine-scale representation of the real world, the data preparation and large-scale 3D inter-visibility computation process tend to be very complex and of high costs.

In comparison, view photography can capture the realistic window views of the outside world with low costs due to well-developed techniques (for example, portable camera sensors and lightweight 3D visualization on geospatial platforms).

Computation of the sky and landscape layer proportions of view images has become a prevailing technique for representing the view openness. Gong et al. (2018) extracted the proportion of sky layer within the street view photo to compute street openness. Xia et al. (2021) further improved the accuracy and efficiency of street view openness using photography. Chang (2021) calculated proportions of sky and landscape layers of window view photos to represent window view openness. However, the quantified distance from view objects which affects window view openness is not involved to enrich the view openness computation. Window views with the same proportion of sky layer but with varied distances to landscape layers fail to be differentiated. Thus, there is a lack of investigation on using window view images with distance information for a more accurate window view openness computation.

### BRIEF SUMMARY OF THE INVENTION

There is a continuous need in the art for improved designs and techniques for a system and methods for quantifying and calculating the Window View Openness Index (WVOI) based on window view images and view distances.

Embodiments of the subject invention pertain to a system and methods for quantifying and calculating window view openness indexes. The method comprises generating a window view image by an image capturing device; computing a distant view layer proportion; measuring and computing a close-range view layer distance; computing a view distance-based openness adjustment factor (OAF); and computing a window view openness index. The generating a window view image comprises defining a plurality groups of settings for the window view image generation. The plurality of groups of setting may comprise a group of setting including orientation attributes including heading, pitch, and tilt. The plurality of groups of setting may comprise a group of setting including view frustum attributes including field of view (FoV). The plurality of groups of setting may comprise a group of setting including positions of the image capturing device in a (x, y, z) coordinate system. Moreover, the computing the proportion of a distant view layer comprises extracting a proportion of a distant layer of the window view image as a basic factor to measure view openness. The measuring and computing a close-range view layer distance are performed by a user or by a computing system. The OAF is summarized from view distances computed in the step of measuring and computing a close-range view layer distance. Further, the window view openness index (WVOI) is calculated based on the proportion of distant view layer and the OAF from the close-range view layer distance.

### BRIEF DESCRIPTION OF THE DRAWINGS

FIG. 1 shows a flow chart of steps of the method for quantifying and calculating window view openness indexes, according to an embodiment of the subject invention.

FIG. 2 is a schematic representation of the step of window view image generation, according to an embodiment of the subject invention.

FIG. 3 is a schematic representation of the step of distant view layer proportion computation, according to an embodiment of the subject invention.

FIG. 4 is a schematic representation of the step of close-range view layer distance measurement and computation, according to an embodiment of the subject invention.

FIG. 5 is a schematic representation of the step of view distance-based openness adjustment factor computation, according to an embodiment of the subject invention.

FIG. 6 is a schematic representation of the step of window view openness index computation, according to an embodiment of the subject invention.

FIGS. 7A-7E show images of an example of the method for quantifying and calculating window view openness indexes, according to an embodiment of the subject invention.

FIGS. 8A-8C show images of window view openness index of exemplary window view pairs with the same sky layer proportion but different non-sky view distances, wherein FIG. 8A shows views with both high sky layer proportions, FIG. 8B shows views without the sky layer, and FIG. 8C shows similar views, according to an embodiment of the subject invention.

### DETAILED DISCLOSURE OF THE INVENTION

The embodiments of subject invention show a method and systems for quantifying and calculating the WVOI using window view images and view distances, aiming to quantify window view openness to facilitate purchasers in housing selection, developers in housing valuation, and urban planners in sustainable planning and design. The method and systems are based on both semantic and distance information of the window view images for quantifying and calculating the WVOI more accurately.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not prelude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

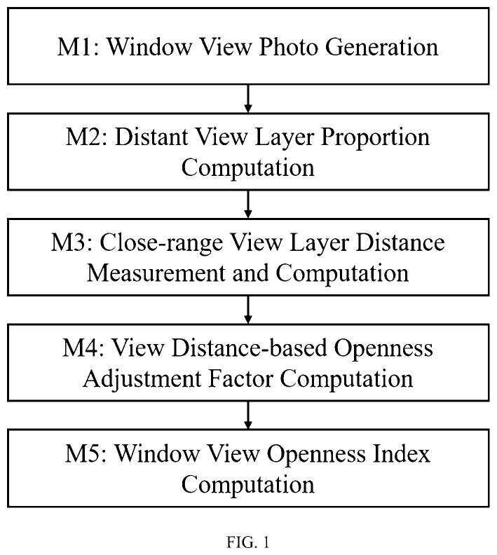

Referring to FIG. 1, the method of the subject invention for quantifying and calculating window view openness indexes comprises five steps. In the first step M1, images of the window view close to a window are captured by a physical camera in the real world or by a virtual camera of a computing system. Then, in the second step M2, a distant view layer proportion is computed by extracting the distant layer elements, for example, sky, through either manual work of a user or computer vision techniques. Next, in the third step M3, the view distances to the rest of the elements, for example, non-sky elements, are measured through manual surveys with aid of ranging sensors or automatic methods such as distance computation by a computing system with a geographical module. Then, in the fourth step M4, the openness adjustment factor (OAF) is computed based on the view distances obtained. Next, the view openness indexes are computed based on the distant layer proportion and the OAF obtained. These steps of the method of the subject invention for quantifying and calculating window view openness indexes are described with greater details below.

### Step 1: Window View Image Generation

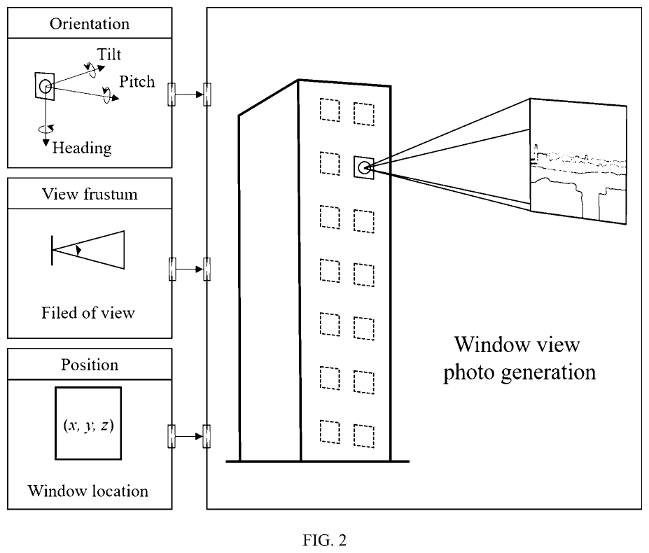

Referring to FIG. 2, window view images are captured by an image capturing device such as a real camera or a virtual camera. A plurality of groups of settings are defined for the image generation. The first group of setting may include orientation attributes, such as pitch, tilt, and heading. The second group of setting may include view frustum attributes, such as field of view (FoV). The third group of setting may include positions of the image capturing device in a (x, y, z) coordinate system. Moreover, the orientation attributes and view frustum attributes are defined to represent the assessed window view scope. Further, the position (x, y, z) of the image capturing device and heading are determined by the window site information. Further, the window view image is captured at the target window position in the real world or a virtual environment as shown in FIG. 2.

### Step 2: Distant View Layer Proportion Computation

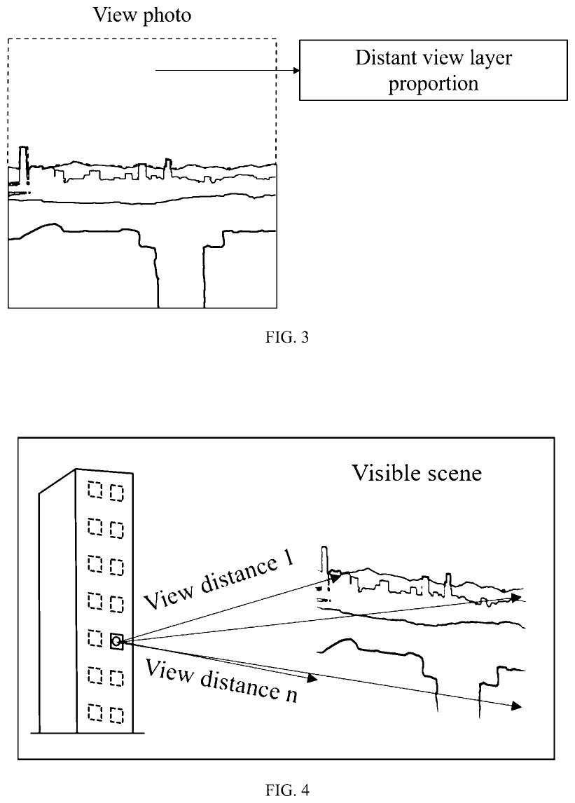

Referring to FIG. 3, the proportion of the distant layer of the window view image is extracted as a basic factor to measure the view openness. The distant layer can be defined as the sky layer or the layer including sky and landscape elements such as buildings, greenery, and waterbody, which are very far away. Setting the sky layer as an example, the process below describes how the proportion of the distant view layer is calculated.

Given an image i with M×N pixels, the proportion of the sky layer, Pᵢ^{sky} is defined as the ratio by Equation (1),

$${P}_{i}^{sky} = \frac{\vert \{ p \vert p ∈ i , λ ( p ) = sky \} \vert}{M \times N} , \qquad ( 1 )$$

where λ(p)=sky is the semantic label of a pixel p, and |⋅| is the cardinality operator indicating the total number of pixels. As a result, the Pᵢ^{sky} is a scalar value bounded between 0 and 1.

The distant view layer proportion, for example, sky proportion Pᵢ^{sky} can be extracted from the window view image through a manual method, such as labeling, or automatic methods such as computer vision techniques.

If the extraction is based on the manual method, the pixels of the elements in the distant layer can be directly recognized, labelled, and summarized by a user. On the other hand, if the extraction is based on the automatic methods, for example, setting machine learning, which is one of the prevailing computer vision techniques, window view image can be initially segmented by the deep learning model based on predefined view element labels, such as sky, waterbody, building, and greenery. Then, the pixels of the labelled view elements in the distant view layer, for example, the sky layer are summarized for the area computation. At the end, the P is computed based on the area of the sky layer over the total area of the whole image i.

### Step 3: Close-Range View Layer Distance Measurement and Computation

Referring to FIG. 4, the distances to the rest of the view elements on the image, namely the target close-range view layer elements such as buildings, greenery, and waterbody can be measured in the real world or computed by computing systems. In the real world, the distances between the target view elements and the window location are measured through surveying instruments, for example, ranging sensors such as LiDAR. On the other hand, in the case of by the computing system, the distances are calculated based on the locations of windows and the target view elements based on a geographical location database. Then, the distance information is saved as distance maps and related to the window view images.

### Step 4: View Distance-Based Openness Adjustment Factor (OAF) Computation

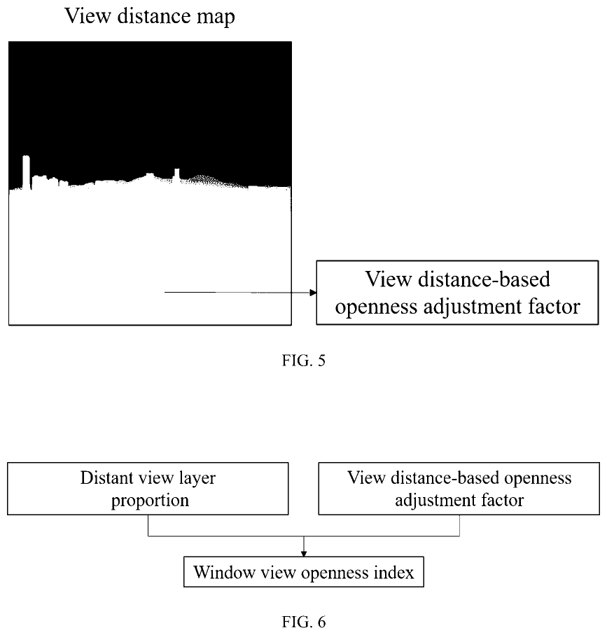

Referring to FIG. 5, the OAF is summarized from the view distances computed in the step 3. The OAF can be any representative statistical value from the close-range view layer distances. Setting the average distance of the non-sky elements, for example, building, greenery, and waterbody in the close-range layer as an example, the OAF calculation steps are described as follows.

Given the non-sky average distance set D of n collected window view images, the OAF is defined as the ratio by Equation (2),

$${I}_{i}^{non - sky} = \frac{{D}_{i}}{max ( D )} , D = \{ {D}_{i} \vert {D}_{i} = \frac{{\sum }_{1}^{m} dist ( {p}_{j} )}{m} , i = 1 , 2 , … , n \} \qquad ( 2 )$$

where Dᵢ is the average view distance of m non-sky pixels in the image i, max and dist are two functions to calculate the maximum value of D, and the view distance to the element on the pixel j, respectively. Thus, the exemplary Iᵢ^{non-sky} is a scalar value bounded between 0 and 1. The higher the Iᵢ^{non-sky}, the more it increases the openness.

The collected view distance information from the step 3 is assigned and matched with the non-sky pixels to compute the Iᵢ^{non-sky}.

### Step 5: Window View Openness Index Computation

Compared to the traditional image-based openness indexes that only involve the view layer proportions (for example, sky proportion), which under-represent the degree of window view openness, the openness index computation of the embodiments of the subject invention is based on the proportion of distant view layer and the OAF from the close-range view layer distance as shown in FIG. 6.

Window view openness indexes based on view proportion and distance can have multiple forms by defining different equations. Using the sky proportion P^{sky} and OAF, I^{non-sky} of the non-sky elements mentioned in the step 2 and the step 4 as an example, an example WVOI is defined by Equation (3),

$$WVOI = {P}^{sky} + ( 1 - {P}^{sky} ) \times {I}^{non - sky} . \qquad ( 3 )$$

Thus, all the examples of WVOIs are scalars bounded between 0 and 1. The higher the WVOI, the more openness the window has. For instance, the view openness of a window with a 50% of sky view and 20% of OAF can be computed as, 50%+(1−50%)×20%=60%.

### Materials and Methods

The key techniques of the embodiments of the subject invention are illustrated with an example case as described below. It should be noted that the case only illustrates the general idea of this invention and is therefore not to be considered limiting its scope. Similar data and methods can also be used to calculate the window view openness following the general workflow as shown in FIG. 1.

### Example of Step 1: Window View Image Generation

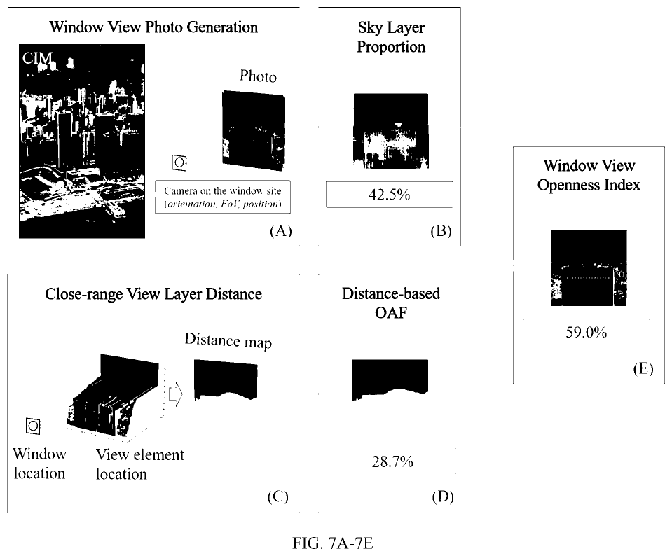

Window view image is generated through a virtual camera on the 3D photo-realistic City Information Model (CIM) platform to showcase the invention as shown in FIG. 7A. The camera orientation attributes including tilt and pitch are both set to 0 and the FoV is set to 60° for the horizontal view capture. Then, the camera position (x, y, z) and the heading are set based on target window site location (ing, lat, height) and the heading information. Next, the two types of window information are extracted from the geographical database. Then, the window view is captured at the target window position and saved as an image.

### Example of Step 2: Distant View Layer Proportion Computation

The sky layer is selected to calculate the basic openness proportion of the window view. The sky layer is detected by a deep learning model, DeepLab V3. The P^{sky} referred to by Equation (1) is calculated by finding the area of the sky layer over the whole area of the image as shown in FIG. 7B.

### Example of Step 3: Close-Range View Layer Distance Measurement and Computation

The distances between the window location and the rest of the view elements on the view image, namely non-sky elements are computed by a computing system. First, the geographical locations of non-sky elements at the target pixel locations of the image are returned from the rendered 3D CIM by setting the virtual camera at the window position (ing, lat, height) with the same parameters such as orientation and FoV parameters referred to step 1. Then, the distances between the window and view objects are computed. Next, the distance information is saved as the distance map and related to the view image as shown in FIG. 7C.

### Example of Step 4: View Distance-Based Openness Adjustment Factor Computation

I^{non-sky} referred to by Equation (2) is used to represent the OAF. First, the average distance between the window location and the non-sky elements is calculated and added to D. Then, the maximum value of the set D is determined as a benchmark. Next, the I^{non-sky} is computed using the ratio of the image average view distance of the non-sky elements to the benchmark, as shown in FIG. 7D.

### Example of Step 5: Window View Openness Index Computation

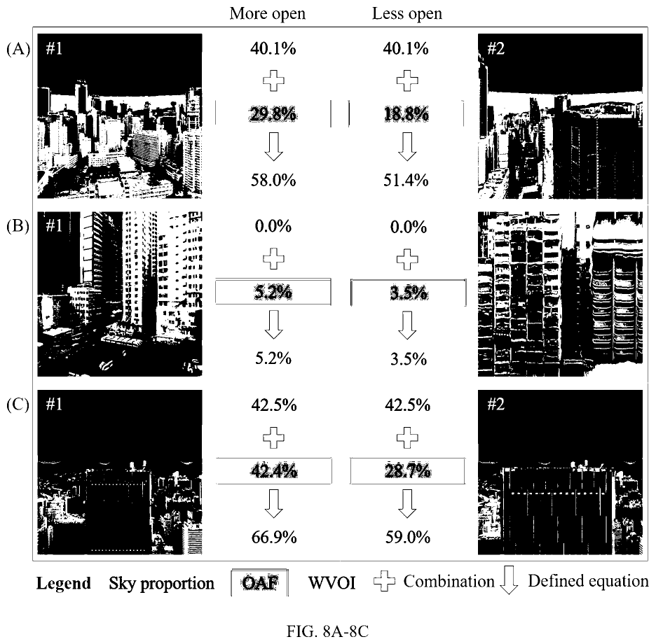

The example WVOI referred to by Equation (3) is used to quantify the window view openness as shown in FIG. 7E. FIGS. 8A-8C show three typical window view pairs and quantified WVOIs to test the feasibility of the embodiment of the subject invention, respectively. According to the legend, numbers in the blue and yellow rectangles indicate the sky proportion and OAF of the view images, respectively, whereas the WVOIs computed by Equation (3) are shown in the grey rectangles. It is found that views in group #1 have the same sky layer proportion, but larger view distances to the non-sky elements compared to those in group #2. And the WVOIs of views in group #1 are thus all larger than views in group #2. The computation results confirm that the system and method of the subject invention can further quantify the fine-scale view openness difference by adding the view distance, even for views with the same proportion of sky elements.

The subject invention utilizes both semantic and distance information of window view images to effectively compute a more accurate WVOI. Compared to the conventional visibility analysis-based view openness measurement, utilization of window view images with distance information not only realizes more accurate quantification, but also avoids the high cost of 3D data processing and inter-visibility computation. Compared to the conventional view-image-content openness estimation method, utilization of window view images with distance information can realize more accurate quantification, especially for views with the same distant layer proportion.

Comparisons with Conventional Technologies

In one prior art (“Method for calculating urban sky openness by utilizing Internet street view photo”, China Patent No. CN202010146662.5A), the sky openness for the street was calculated, the openness was calculated based on the skyline analysis, and the sky proportion of the street view photos was used to calculate the sky openness, which did not involve the view distance calculation.

In contrast, in the subject invention, the window view openness involving sky and landscape layer proportions and view distance for the residence is calculated from multiple levels, and high-rise residential window views cannot be represented by street view photos.

In another prior art (“information processing method for building space openness based on three-dimensional model”, China Patent No. CN201911126596.9A), a method was provided to estimate space openness for different building designs through 3D models. The openness of different indoors layout designs was measured, the model focused on a single building level, and traditional visibility analysis was used to measure the space openness.

In contrast, in the subject invention, the window view openness to the outside world is measured, the window view openness at the urban scale is measured, and view photography with view distance information is used.

In yet another prior art (“method and apparatus for automating observer-centered analysis of viewing area in urban center using 3D sensor data”, Korea Patent No. KR1019739030000*), a method and apparatus are provided to measure the viewing area of the urban center from an observer-centered perspective. The exposed area to the sky of the urban center was measured and the traditional visibility analysis was used.

In contrast, in the subject invention, multilevel window view openness is analyzed and window view images with view distance information are used.

Therefore, compared with the traditional quantification of view openness, the system and method of the subject invention can compute an openness index more accurately for differentiating diversified window views, benefitting a number of related disciplines and fields including real estate valuation and sustainable urban planning and design.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

1. Chang, C. Y. (2021). Window view quality: investigation of measurement method and proposed view attributes (Doctoral dissertation, University of Sheffield).
2. Fisher-Gewirtzman, D. (2018). “Integrating ‘weighted views’ to quantitative 3D visibility analysis as a predictive tool for perception of space. Environment and Planning B: Urban Analytics and City Science, 45(2), 345-366. doi:10.1177/0265813516676486
3. Gong, F.-Y., Zeng, Z.-C., Zhang, F., Li, X., Ng, E. & Norford, L. K. (2018). Mapping sky, tree, and building view factors of street canyons in a high-density urban environment. Building and Environment, 134, 155-167. doi:10.1016/j.buildenv.2018.02.042
4. Xia, Y., Yabuki, N. & Fukuda, T. (2021). Sky view factor estimation from street view images based on semantic segmentation. Urban Climate, 40, 100999. doi: 10.1016/j.uclim.2021.100999

1. A method for quantifying and calculating window view openness indexes based on window view photos and view distances, the method comprising:
generating a window view image by an image capturing device;
computing a distant view layer proportion;
measuring and computing a close-range view layer distance;
computing a view distance-based openness adjustment factor (OAF); and
computing a window view openness index.

2. The method of claim 1, wherein the generating a window view image comprises defining a plurality of groups of setting for the window view image generation.

3. The method of claim 1, wherein the plurality of groups of setting comprises a group of setting including orientation attributes including heading, pitch, and tilt.

4. The method of claim 1, wherein the plurality of groups of setting comprises a group of setting including view frustum attributes including field of view (FoV).

5. The method of claim 1, wherein the plurality of groups of setting comprises a group of setting including positions of the image capturing device in a (x, y, z) coordinate system.

6. The method of claim 1, wherein the quantifying and computing a distant view layer proportion comprises extracting a proportion of a distant layer of the window view image as a basic factor to measure view openness.

7. The method of claim 1, wherein the measuring and computing a close-range view layer distance are performed by a user or by a computing system.

8. The method of claim 1, wherein the OAF is summarized from view distances computed in the step of measuring and computing a close-range view layer distance.

9. The method of claim 1, wherein the window view openness index (WVOI) is calculated based on the proportion of distant view layer and the OAF from the close-range view layer distance.

10. A computer-readable storage medium having stored therein program instructions that, when executed by a processor of a computing system, cause the processor to execute a method for quantifying and calculating window view openness indexes based on window view images and view distances, the method comprising:
generating a window view image by an image capturing device;
computing a distant view layer proportion;
measuring and computing a close-range view layer distance;
computing a view distance-based openness adjustment factor (OAF); and
computing a window view openness index.

11. The computer-readable storage medium of claim 10, wherein the generating a window view image comprises defining a plurality of groups of setting for the window view image generation.

12. The computer-readable storage medium of claim 10, wherein the plurality of groups of setting comprises a group of setting including orientation attributes including heading, pitch, and tilt.

13. The computer-readable storage medium of claim 10, wherein the plurality of groups of setting comprises a group of setting including view frustum attributes including field of view (FoV).

14. The computer-readable storage medium of claim 10, wherein the plurality of groups of setting comprises a group of setting including positions of the image capturing device in a (x, y, z) coordinate system.

15. The computer-readable storage medium of claim 10, wherein the computing a distant view layer proportion comprises extracting a proportion of a distant layer of the window view image as a basic factor to measure view openness.

16. The computer-readable storage medium of claim 10, wherein measuring and computing a close-range view layer distance are performed by a user or by a computing system.

17. The computer-readable storage medium of claim 10, wherein the OAF is summarized from view distances computed in the step of measuring and computing a close-range view layer distance.

18. The computer-readable storage medium of claim 10, wherein the window view openness index (WVOI) is calculated based on the proportion of distant view layer and the OAF from the close-range view layer distance.

19. A window view openness index quantifying and calculating system, comprising:
an image generator generating a window view image; and
a processor configured to:
compute a distant view layer proportion;
measure and compute a close-range view layer distance;
compute a view distance-based openness adjustment factor (OAF); and
compute a window view openness index.
